(19) United States
(12) Patent Application Publication
(10) Pub. No.: US 2013/0020204 A1
(43) Pub. Date: Jan. 24, 2013

(54) MAGNETIC WRITE HEAD HAVING AN ELECTROPLATED WRITE POLE WITH A LEADING EDGE TAPER

(71) Applicants: Donald G. Allen, Morgan Hill, CA (US); Liubo Hong, San Jose, CA (US); Aron Pentek, San Jose, CA (US); Thomas J. A. Roucoux, San Jose, CA (US); Junsheng Yang, San Jose, CA (US); Yi Zheng, San Ramon, CA (US); Qiping Zhong, San Jose, CA (US); Honglin Zhu, Fremont, CA (US)

(72) Inventors: Donald G. Allen, Morgan Hill, CA (US); Liubo Hong, San Jose, CA (US); Aron Pentek, San Jose, CA (US); Thomas J. A. Roucoux, San Jose, CA (US); Junsheng Yang, San Jose, CA (US); Yi Zheng, San Ramon, CA (US); Qiping Zhong, San Jose, CA (US); Honglin Zhu, Fremont, CA (US)

(73) Assignee: Hitachi Global Storage Technologies Netherlands B. V., Amsterdam (NL)

(21) Appl. No.: 13/187,381

(22) Filed: Jul. 20, 2011

(51) Int. Cl. G11B 5/127; C25D 7/00; C23F 1/04; C25D 5/02

(52) U.S. Cl. 205/122; 216/22

(57) ABSTRACT

A method for manufacturing a magnetic write head having a tapered leading edge. The method includes depositing a sacrificial non-magnetic layer to a thickness that is at least as great as the thickness of the write pole to be formed. The sacrificial non-magnetic layer is then masked and ion milled so as to form a tapered edge on the sacrificial non-magnetic layer that extends through the thickness of the non-magnetic fill layer. A magnetic material is then deposited and planarized by chemical mechanical polishing. The remaining magnetic material forms the entirety of the magnetic write pole so that there is no need to deposit additional magnetic layers further construct the write pole.

### FIELD OF THE INVENTION

The present invention relates to perpendicular magnetic recording and more particularly to a method for manufacturing a magnetic write head having a leading edge taper.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head can include a magnetic write pole and a magnetic return pole, the write pole having a much smaller cross section at the ABS than the return pole. The magnetic write pole and return pole are magnetically connected with one another at a region removed from the ABS. An electrically conductive write coil induces a magnetic flux through the write coil. This results in a magnetic write field being emitted toward the adjacent magnetic medium, the write field being substantially perpendicular to the surface of the medium (although it can be canted somewhat, such as by a trailing shield located near the write pole). The magnetic write field locally magnetizes the medium and then travels through the medium and returns to the write head at the location of the return pole where it is sufficiently spread out and weak that it does not erase previously recorded bits of data.

A magnetoresistive sensor such as a GMR or TMR sensor can be employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to maximize data density it is important to minimize the bit length of a magnetic bit of data recorded by the write head. It is also necessary to maximize the write field and to maximize the amount of magnetic flux that can be delivered to the tip of the write pole.

### SUMMARY OF THE INVENTION

The present invention provides a method for manufacturing a magnetic write head that includes depositing a non-magnetic layer to a thickness that is at least as thick as a write pole to be formed, and forming a first mask having an edge. An ion milling is performed to remove a portion of the sacrificial layer, the ion milling being performed so that shadowing from the mask forms a tapered surface on the non-magnetic layer. A magnetic material is then deposited, the tapered surface on the non-magnetic layer resulting in a leading edge taper on the magnetic material. A trailing edge taper is then formed on the magnetic material.

The trailing edge taper can be formed on the magnetic material by a non-magnetic step structure over the magnetic material, the step structure having a front edge that is located a desired distance from an intended air bearing surface plane. A non-magnetic material can then be deposited, and an ion milling can be performed to remove horizontally disposed portions of the non-magnetic material, leaving a non-magnetic bump formed on the front edge of the non-magnetic step. Further ion milling can then be performed to form a tapered surface on the magnetic layer.

The present invention advantageously allows the magnetic write pole to be deposited in a single deposition of magnetic material while still forming the write pole with a tapered leading edge. This is possible because the sacrificial non-magnetic layer has a thickness that is at least as great as the thickness of the write pole. The ion milling performed to form a tapered surface on the sacrificial non-magnetic layer can be performed sufficiently to allow the tapered surface to extend completely through the sacrificial non-magnetic layer. Then, when the magnetic material is deposited, it can be deposited at least as thick as the thickness of the sacrificial non-magnetic layer. After the chemical mechanical polishing process is performed, the remaining magnetic material forms the entire thickness of the write pole.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention; and

FIGS. 4-29 are views of a magnetic write head in various intermediate stages of manufacture, illustrating a method of manufacturing a magnetic write head according to an embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

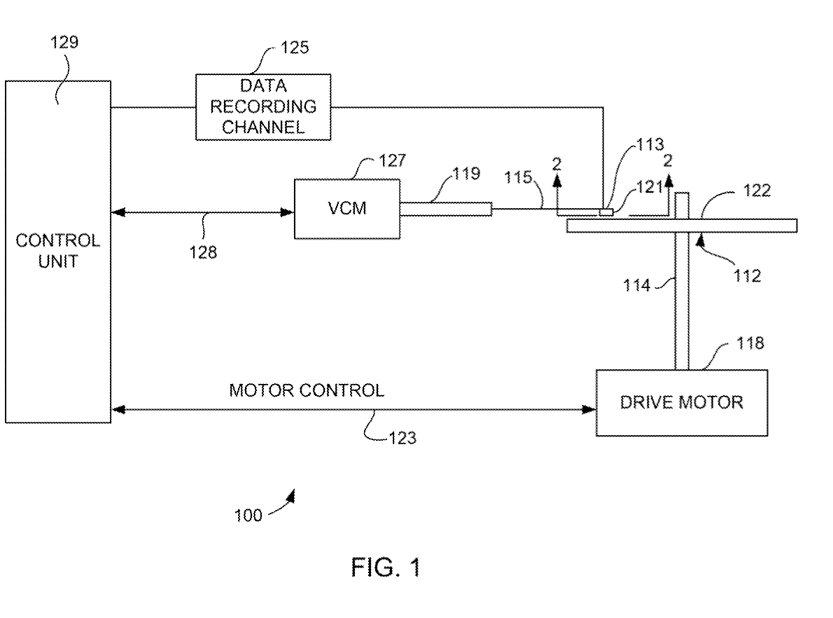

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

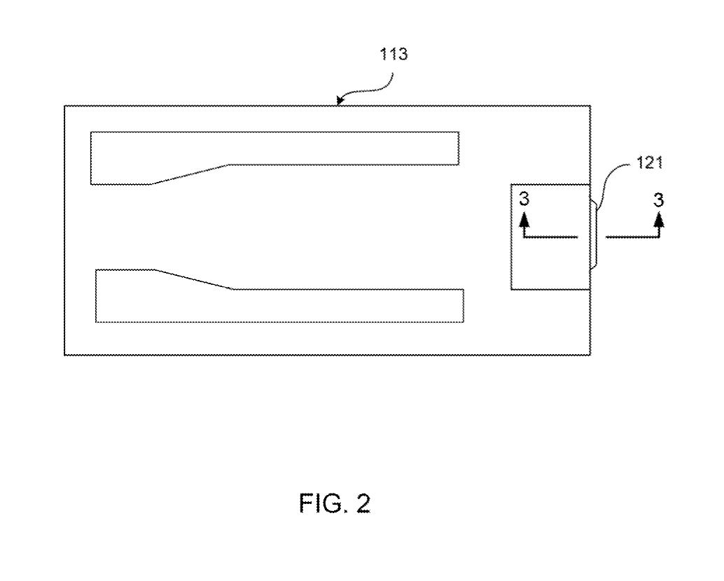

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

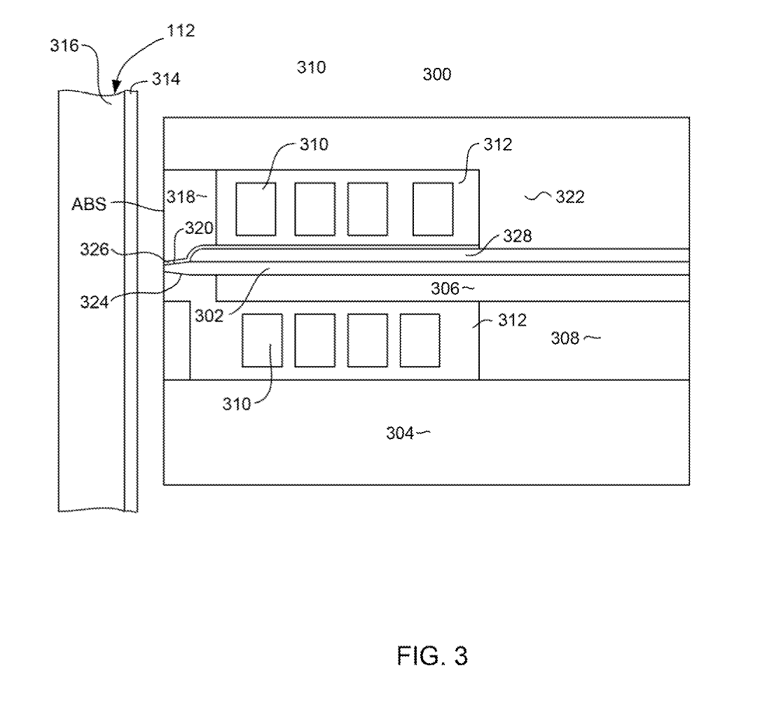

FIG. 3 is a side cross sectional view of a magnetic write head 300 that can be constructed by a method of the present invention. The write head 300 includes a magnetic write pole 302 and a magnetic return pole 304. The magnetic write pole 302 can be connected with a magnetic shaping layer 306 that helps to conduct magnetic flux to the tip of the write pole 302. The write pole 302 and shaping layer 306 can be connected with the magnetic return pole 304 by a magnetic back gap structure 308. A non-magnetic, electrically conductive write coil 310 passes between the return pole 304 and the write pole and shaping layer 302, 306, and may also pass above the write pole and shaping layer 302, 306. The write coil 310 can be encased in a non-magnetic, electrically insulating material 312, which can be a material such as alumina and/or hard baked photoresist. When an electrical current flows through the write coil 310 a magnetic field is induced around the coil 310 that results in a magnetic flux flowing through the return pole 304, back gap layer 308, shaping layer 306 and write pole 302. This results in a write field being emitted from the tip of the write pole 302. This strong, highly concentrated write field locally magnetizes a magnetic top layer 314 of the magnetic media 112. The magnetic field then travels through a soft magnetic under-layer 316 of the magnetic media before returning to the return pole 304, where it is sufficiently spread out and weak that it does not erase the previously recorded bit of data. The write head 300 can also include a magnetic pedestal 305, at the ABS that acts as a shield to prevent stray fields, such as those from the write coil 310 from reaching the magnetic medium 112.

The write head 300 also includes a trailing magnetic shield 318, located at the air bearing surface (ABS) and separated from the write pole 302 by a non-magnetic trailing gap layer 320. The trailing magnetic shield 318 can be connected with the other magnetic structures at the back of the write head 300 by a trailing magnetic pole 322. As shown in FIG. 3, the write pole 302 has a tapered leading edge 324 and a tapered trailing edge 326 that help to channel magnetic flux to the pole tip and help to reduce data bit length. The write head 300 also includes a non-magnetic step or spacer layer 328 that terminates short of the air bearing surface (ABS). The magnetic spacer increases the magnetic spacing between the shield 318 at a location removed from the ABS, but allows smaller magnetic spacing between the write pole 302 and shield 318 at the ABS. This structure optimizes write field gradient improvement while also minimizing the loss of write field to the trailing shield 318. This structure also allows the throat height (thickness measured from the ABS) of the trailing shield 318 to be increased to prevent magnetic saturation of the trailing shield 318 without risking loss of magnetic write field from the write pole 302 to the shield 318.

The write pole 302, with its tapered leading and trailing edges 324, 326 as well as the non-magnetic spacer 328, non-magnetic trailing gap layer 326 and trailing magnetic shield 318 can be constructed by a process that will be described herein below.

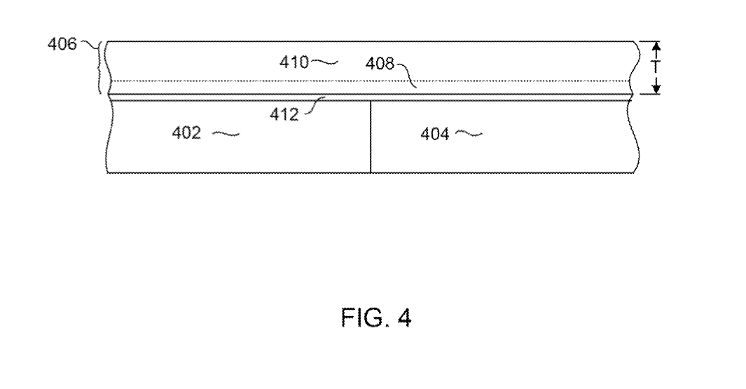

FIGS. 4-20 show a magnetic write head and in various intermediate stages of manufacture and illustrate a method for manufacturing a magnetic write head according to an embodiment of the invention. With particular reference to FIG. 4, a magnetic structure 404 and non-magnetic fill layer are formed. The magnetic layer 404 corresponds with the magnetic shaping layer 306 of FIG. 3 and can be constructed of a magnetic material such as Co—Fe or Ni—Fe. The non-magnetic layer 402 corresponds with the non-magnetic fill layer 312 of FIG. 3 and can be constructed of a material such as alumina. The structure 402, 404 can be planarized by a method such as chemical mechanical polishing (CMP) to form them with flat co-planar surfaces.

Then, a sacrificial non-magnetic layer 406 is deposited over the structures 402, 404. Unique to the present invention, the sacrificial layer 406 is deposited to a thickness (T) that is about equal to or at least as thick as the thickness of a desired write pole (yet to be formed). The sacrificial layer 406 can be constructed of various hard, non-magnetic materials, but is preferably constructed of one or more layers of Cr, Ni—Cr or Ru. More preferably the layer 406 is constructed of a layer of Cr or NiCr 408 and a layer of Ru 410 deposited there-over. The layer 408 is preferably deposited to a thickness of 150-240 nm or about 200 nm. The layer 410 is preferably deposited to a thickness of 20 to 60 nm or about 40 nm. The material 408 is chosen to have an ion mill rate close to the main pole 302 material. Material 410 preferably has a low polich rate and is resistant to chemical mechanical polishing (CMP). A thin layer 412 may also be deposited over the structure 402, 404 prior to the deposition of the sacrificial layer 406. This layer 406 can be a material such as Ta that can function as an adhesion layer for the above applied sacrificial layer 406, but which can function as an end point detection layer for an ion milling process that will be described herein below.

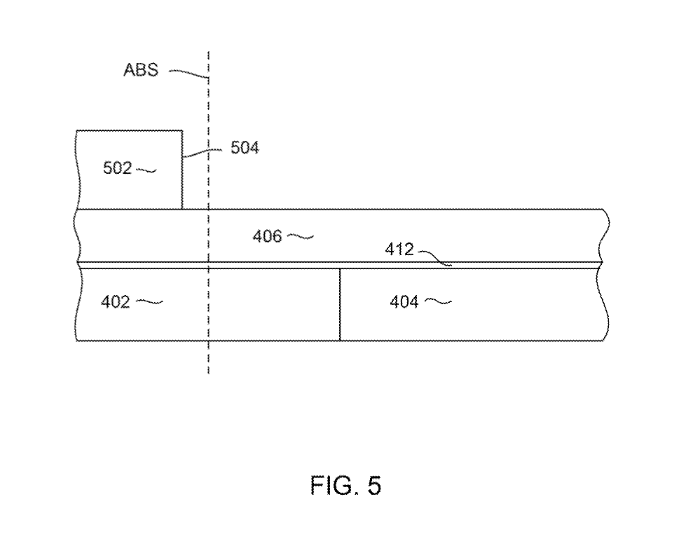

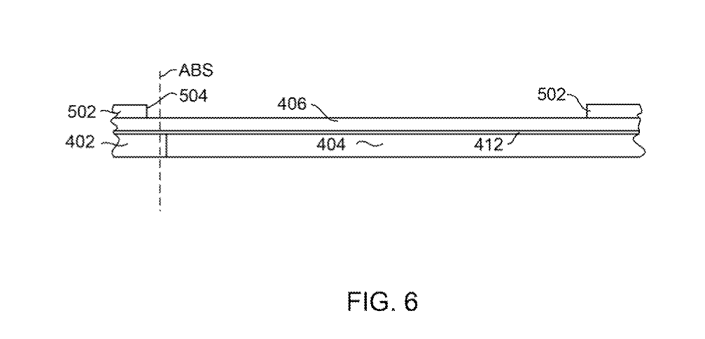

With reference now to FIG. 5, a mask structure 502 is formed over the sacrificial, non-magnetic layer 406. The mask structure 502 is formed with an edge 504 that will define an initiation point of a taper, as will be seen. Therefore, the edge 504 is located at a desired location relative to a location of an intended air bearing surface plane indicated by dashed line (ABS). The mask 502 includes a lithographically patterned photoresist, but may also include other layers or materials such as one or more hard mask layers an image transfer layer and/or a bottom anti-reflective coating. FIG. 6 shows an expanded view of the structure of FIG. 5. In FIG. 6 it can be seen that the mask 502 covers a larger area than actually indicated by FIG. 5 alone. In FIG. 6 it can be seen that the mask 502 has an opening that exposes a desired portion of the sacrificial layer 406.

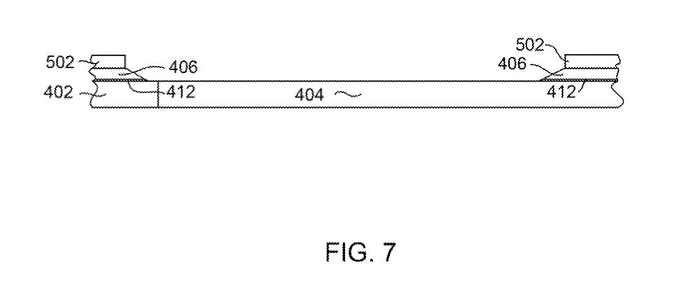

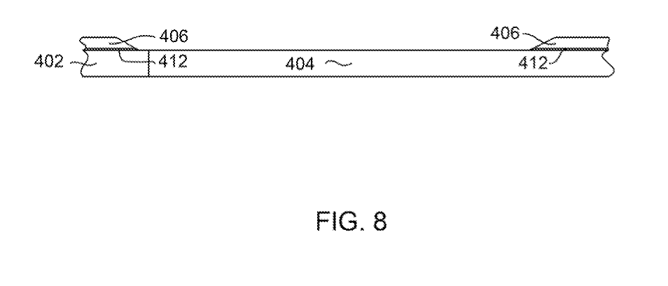

An ion milling process is then performed to remove a portion of the layer 406 that is exposed through the opening in the mask 502. An end point detection process such as Secondary Ion Mass Spectrometry (SIMS) can be used to detect the adhesion/end point detection layer 412. The ion milling is performed at such an angle and in such a manner that shadowing from the mask 502 causes the ion milling to form a tapered surface 702 on the remaining sacrificial layer 412 as shown in FIG. 7. The ion milling is preferably performed in such a manner to form the tapered surface 702 with an angle of 15 to 45 degrees or about 30 degrees. Then, the mask 502 can be lifted, such as by a chemical liftoff process, leaving a structure such as that shown in FIG. 8.

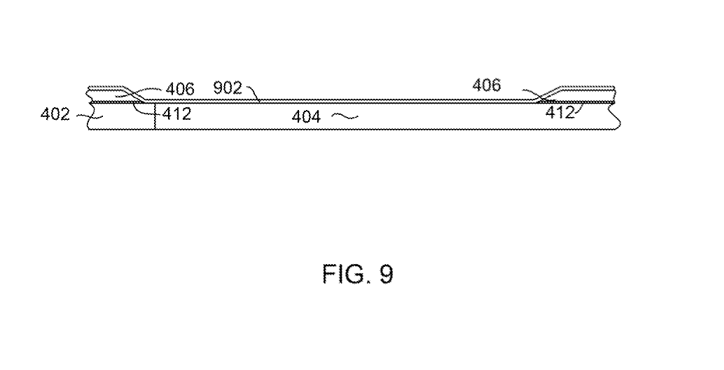

With reference now to FIG. 9, an electrically conductive seed layer 902 is deposited by process such as sputter deposition. The seed layer can include multiple layers, such as 20 Angstroms of Cr plus 80 Angstroms of Ru plus 110 Angstroms of Co—Fe—Ni or CoFe. In this example the Cr is and adhesion layer. The second layer (Ru) is a high Z-value material that is visible in crossectional FIB so that the LET angle and position can be measured properly. The third layer (CoFeNi or CoFe) is a magnetic seedlayer that will be used for electroplating as described next. These layer as given as example only and other materials can also be used.

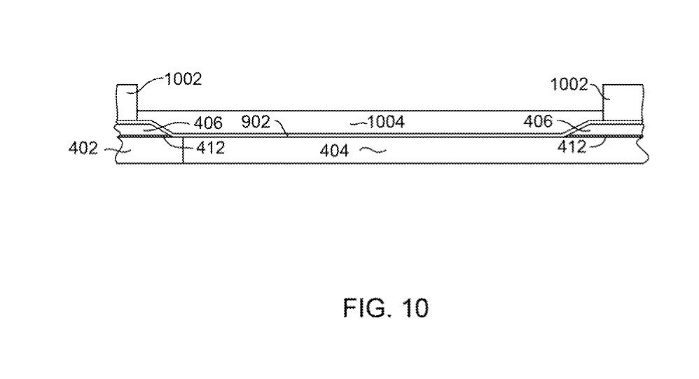

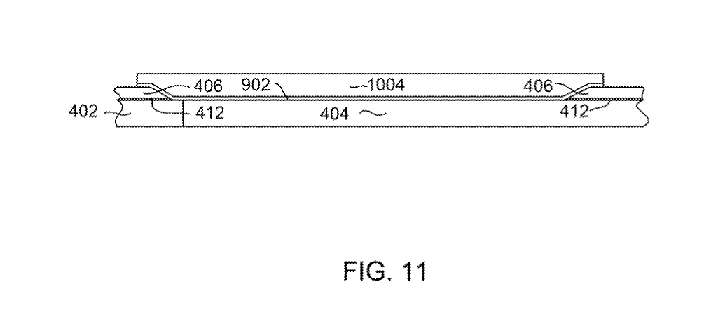

Then, with reference to FIG. 10, an electroplating frame mask 1002 is formed having an opening configured to define the plating location of a magnetic material that will become the write pole. With the mask 1002 formed, an electroplating process is performed to deposit a magnetic material 1004. The magnetic material 1004 is preferably Co—Fe—Ni, and is preferably electroplated to a thickness of about 250-350 nm or about 300 nm. The mask 1002 can then be lifted off, leaving a structure such as that shown in FIG. 11. While electroplating has been described above as a method for depositing the magnetic material 1004, other methods could be used to deposit the magnetic material 1004, such as for example, sputter deposition.

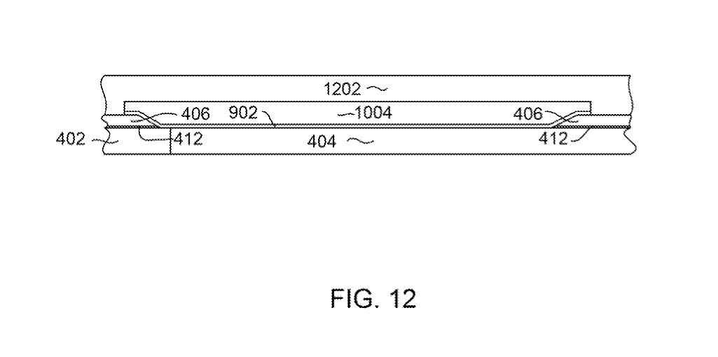

With reference now to FIG. 12, a fill layer 1202 is deposited. The fill layer is preferably alumina Al₂O₃ deposited to a thickness of 400-500 nm or about 450 nm. The fill layer 1202 provides a hard surface in the field region to facilitate chemical mechanical polishing, as will be seen.

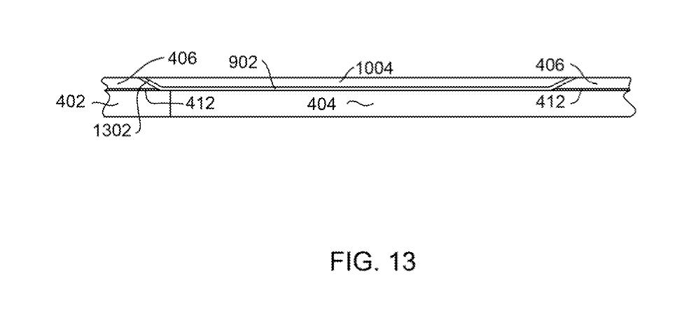

Then, a chemical mechanical polishing process is performed. The chemical mechanical polishing process is performed until the magnetic layer 1004 has a desired write pole thickness and until the sacrificial layer 406 has been reached, leaving a structure as shown in FIG. 13. These above processes form a magnetic write pole (magnetic layer 1004) having a tapered leading edge 1302.

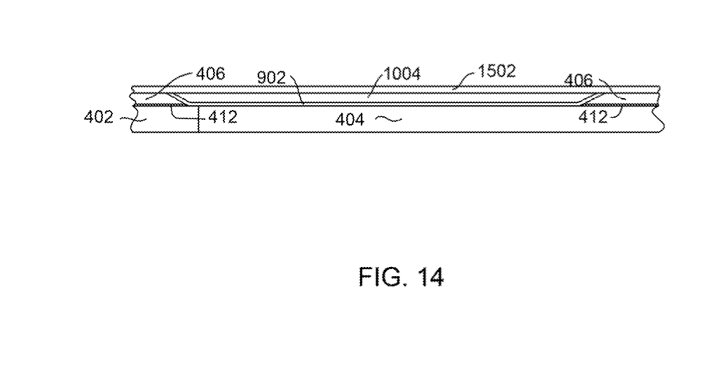

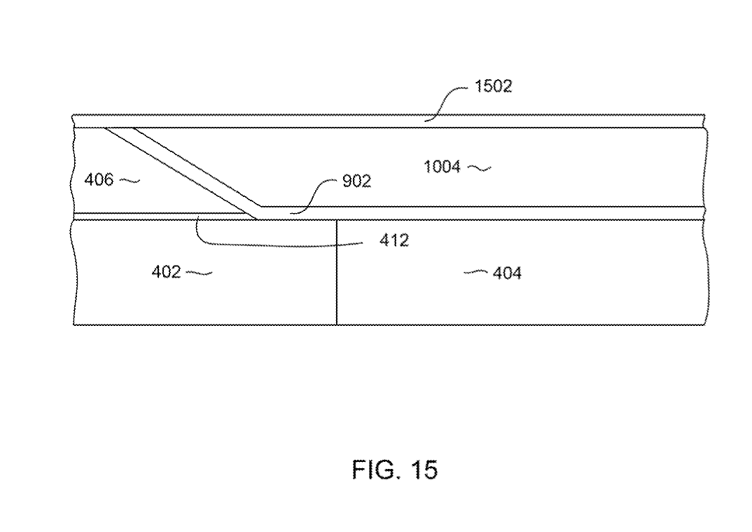

Then, with reference to FIG. 14, a hard mask layer material 1502 is deposited. This layer 1502 can be Ni—Cr and has a thickness that is sufficient to withstand ion milling processes that will be described herein below. To this end, the layer 1402 can be deposited to a thickness of 450 to 550 Angstroms or about 500 Angstroms. FIG. 15 shows an enlarged view of the structure of FIG. 14 in the region of the write pole leading edge taper 1302.

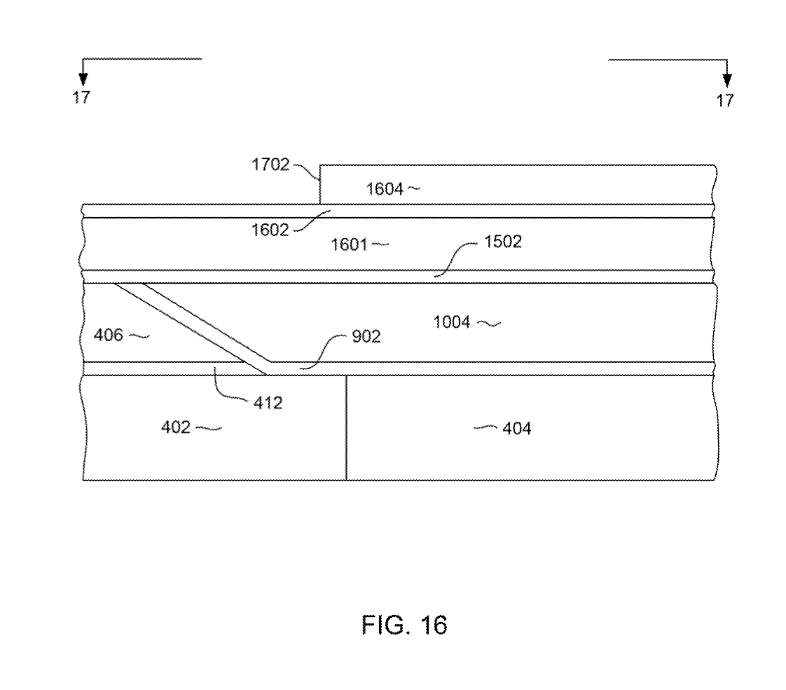

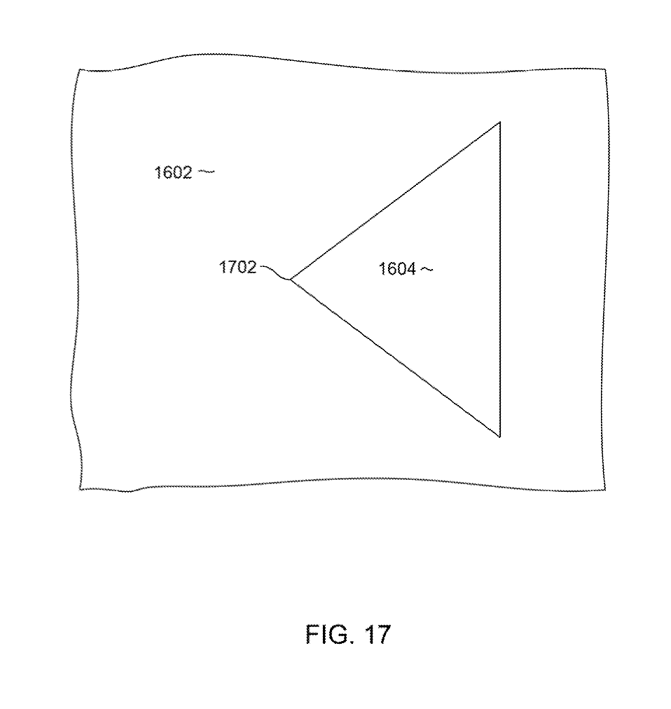

Then, with reference to FIG. 16, non-magnetic spacer layer 1601 is deposited over the first hard mask 1502. The non-magnetic spacer layer 1502 corresponds with the spacer 328 of FIG. 3. The layer 1502 can be constructed of a material such as Si—C and is deposited to a thickness that is chosen to provide a desired magnetic spacing between the trailing shield 318 and write pole 302 as shown in FIG. 3. To this end, the non-magnetic spacer layer 1601 can be deposited to a thickness of 160-170 nm or about 165 nm. A reactive ion etching mask (RIE mask) layer 1602 is deposited over the non-magnetic spacer layer 1601. The RIE mask layer 1602 can be constructed of a material such as Cr and can be deposited to a thickness of 10-20 nm or about 15 nm. Then, a photoresist layer 1604 is deposited over the second hard mask layer 1602. The photoresist layer 1604 is photolithographically patterned and developed to form a mask 1604 that can be seen more clearly with reference to FIG. 17, which shows a top down view as seen from line 17-17 of FIG. 16. As can be seen, the mask 1604 can be in the form of a triangle with a point 1702 that is also shown as the front-most point of the mask 1604 in FIG. 16.

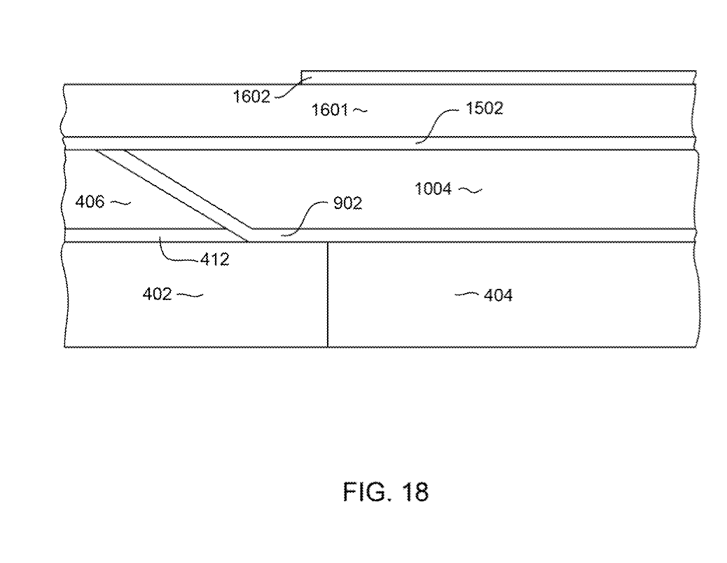

An ion milling can then be performed to transfer the image of the resist mask 1604 onto the underlying RIE mask layer 1602 by removing portions of the layer 1602 that are not protected by the photoresist mask 1604. The photoresist can then be removed, such as by a chemical liftoff process, leaving a structure such as that shown in FIG. 18.

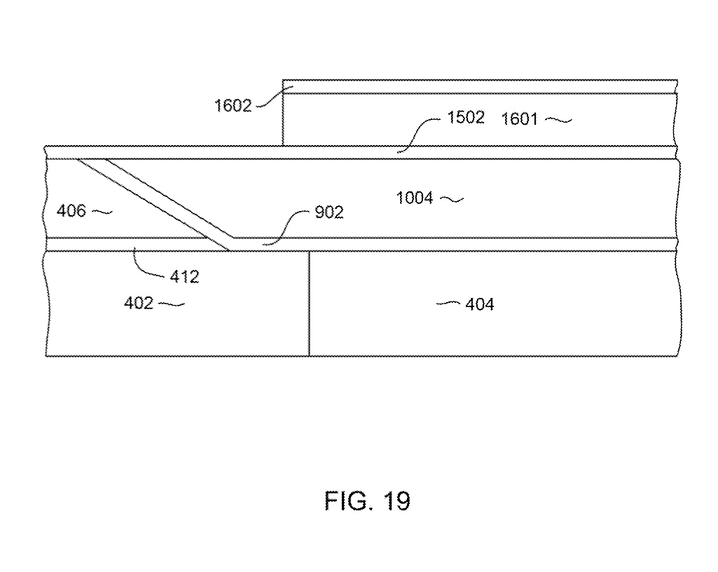

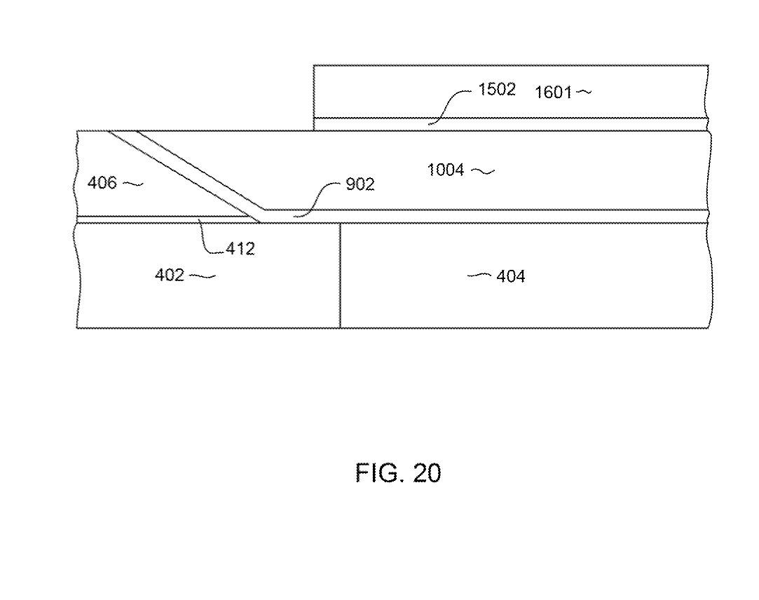

Then, reactive ion etching is performed to remove portions of the non-magnetic step layer 1601 that are not protected by the RIE mask 1602, leaving a structure such as that shown in FIG. 19. If the layer 1601 is constructed of Si—C, the reactive ion etching can be performed using an SF6 chemistry, which readily removes Si—C at a much faster rate than the RIE mask 1602. A second ion milling can then be performed to remove portions of the first hard mask layer 1602 that are not protected by the non-magnetic spacer layer 1602 to transfer the image of the spacer 1601 onto the underlying hard mask 1502, leaving a structure such as that shown in FIG. 20.

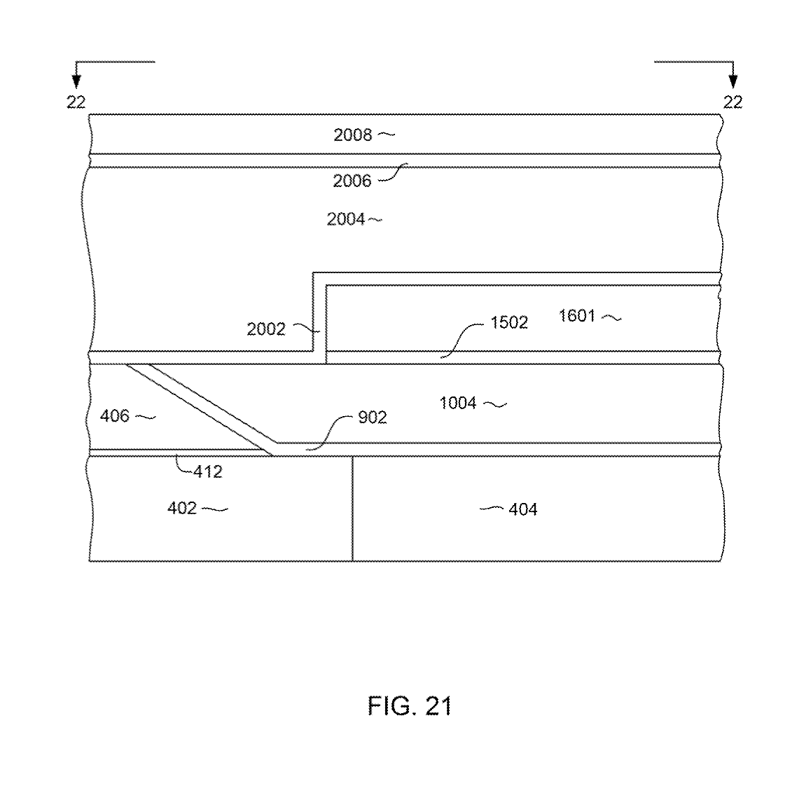

With reference to FIG. 21, a series of mask layers 2001 are deposited over the layers 902, 1003 and 1601. The mask layers 2101 can include a first hard mask layer 2002, image transfer layer 2004, second hard mask layer 2006 and a photoresist layer 2008. The hard mask layer 2002 is preferably a multilayer structure that includes: a layer of carbon having a thickness of 20-30 nm or about 25 nm; a layer of Ta having a thickness of 1-5 nm or about 2 nm deposited over the carbon layer that functions as an end point detection layer; and a layer of alumina (Al₂O₃) having a thickness of 25-35 nm or about 30 nm deposited over the layer of Ta. The image transfer layer 2004 can be a soluble polyimide material such a DURIMIDE® and can be deposited to a thickness of 1.1 to 1.2 micrometers. The second hard mask layer 2006 can be constructed of Si.

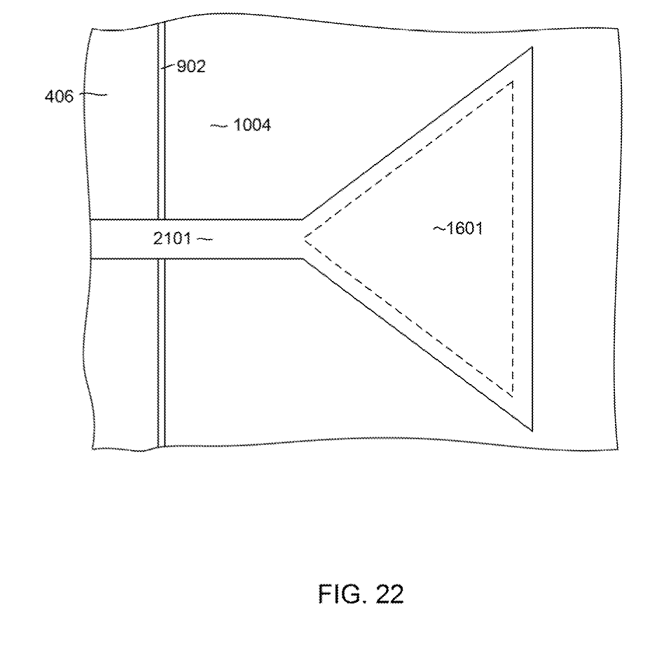

The photoresist mask 2008 is photolithographically patterned and developed to define a write pole shape. Then a combination of reactive ion etching and ion milling is performed to transfer the image of the patterned photoresist onto the underlying mask layers 2002, 2004, 2006. The shape of the resulting mask structure can be seen more clearly with reference to FIG. 22 which shows a top down view as seen from line 22-22 of FIG. 21. In FIG. 22, the outline of the non-magnetic spacer layer 1601 is shown in dashed line to indicate that it is hidden beneath the mask layers 2101.

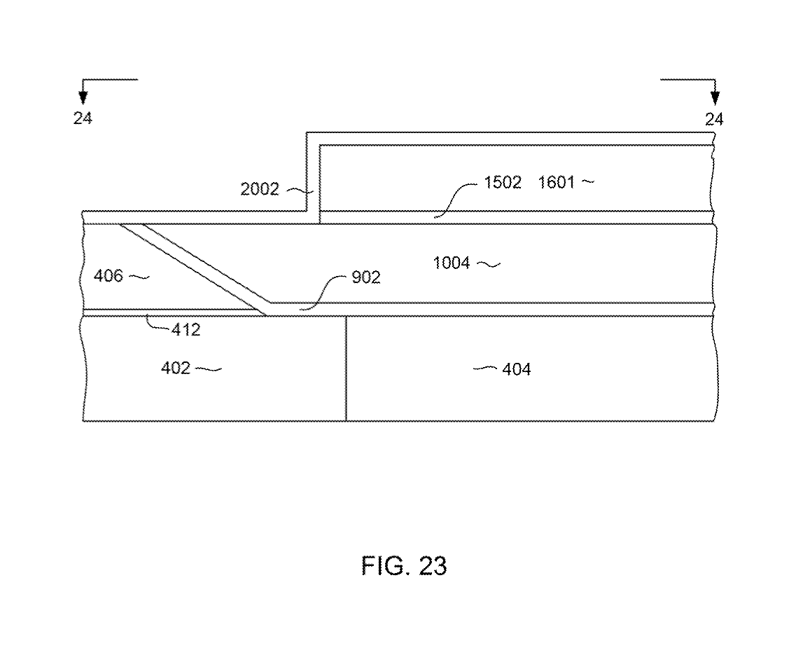

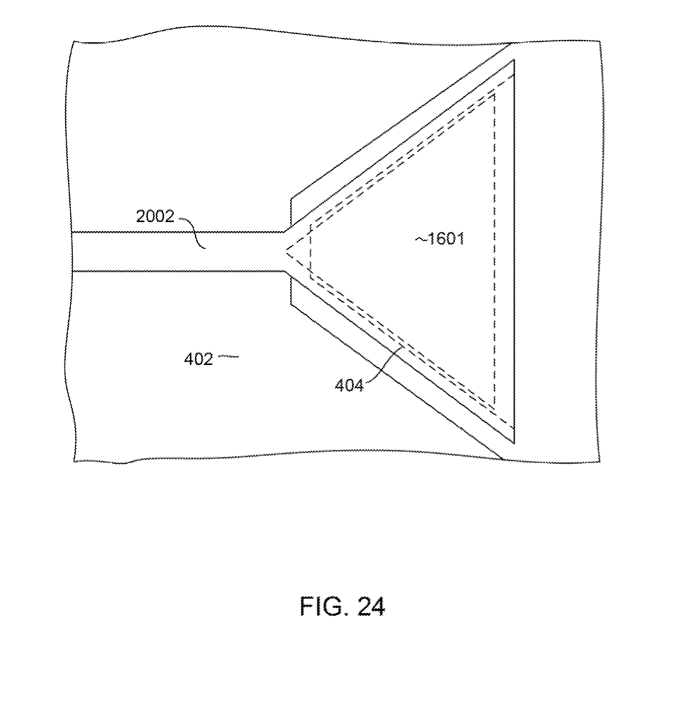

After patterning the mask layers 2101, an ion milling process is performed to remove portions of the magnetic material 1004 that are not protected by the mask 2101 in order to define a write pole. The ion milling is preferably a sweeping ion milling that is performed at one or more angles relative to normal to form a write pole with tapered sides (not shown). After the ion milling, any remaining photoresist 2008, hard mask 2006 (if any) and image transfer layer 2004 can be removed, such as by a chemical liftoff process, leaving a structure such as that shown in FIG. 23. FIG. 24 shows a top down view of the structure of FIG. 23 as seen from line 24-24 of FIG. 23.

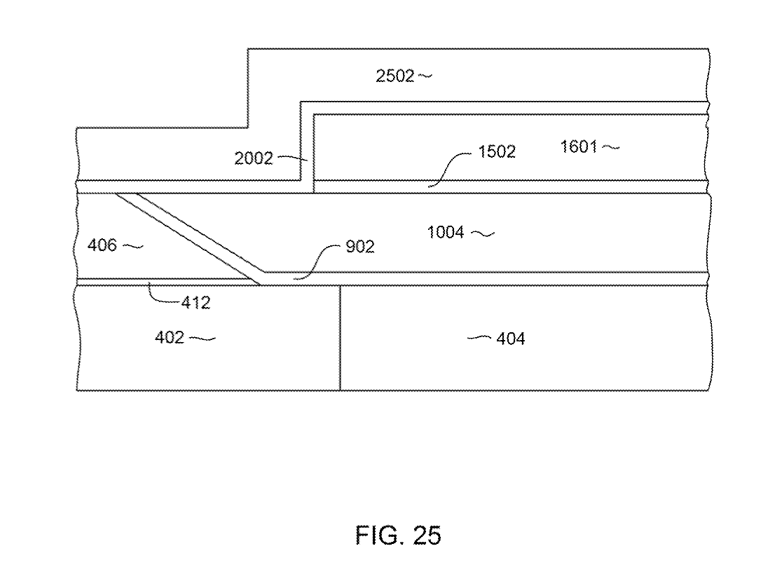

Then, with reference to FIG. 25, a layer of alumina (Al₂O₁) 2502 is deposited. The alumina layer 2502 can be deposited to a thickness of 60-100 nm or about 80 nm. The alumina layer 2502 is preferably deposited by a conformal deposition process such as atomic layer deposition (ALD).

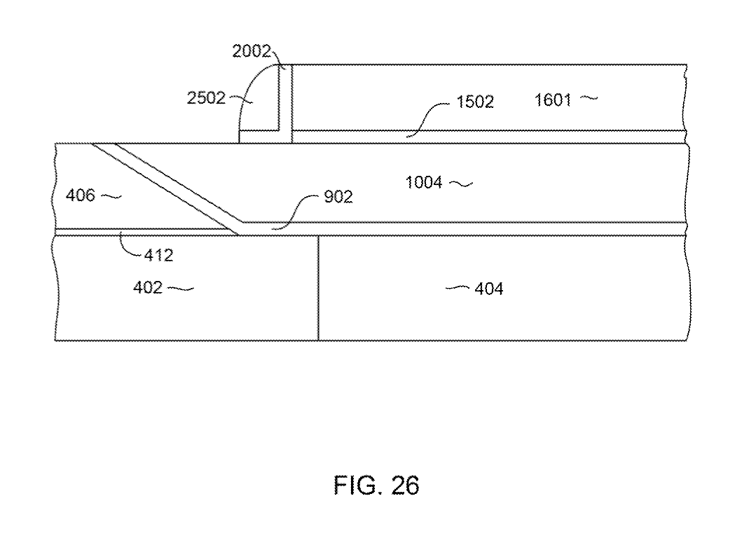

Then, an ion milling is performed to remove horizontally disposed portions of the layers 2002, 2502, but leaving a bump of these materials 2002, 2502 on the end of the spacer 1601 as shown in FIG. 26. The ion milling is performed sufficiently to remove the hard mask 2002 from the top of the layers 1601, 1004 by using an end point detection method such as Secondary Ion Mass Spectrometry (SIMS) to detect the presence of the Ta within the hard mask 1502 and ion milling proceeds to just past the Ta layer.

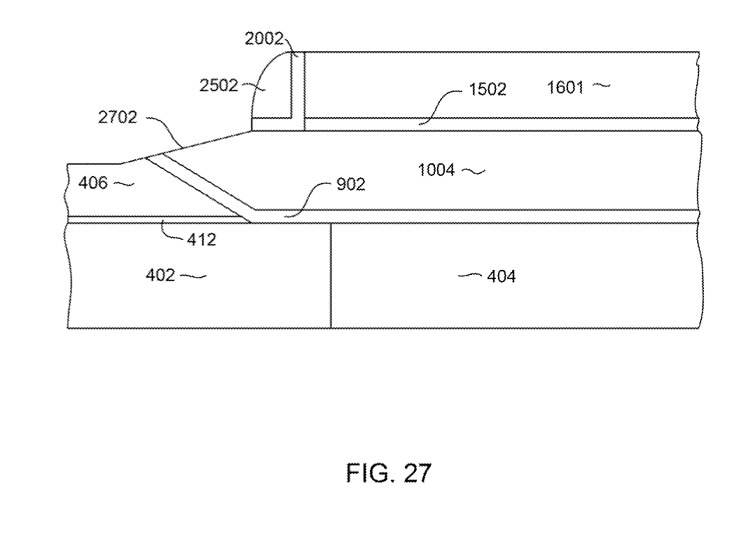

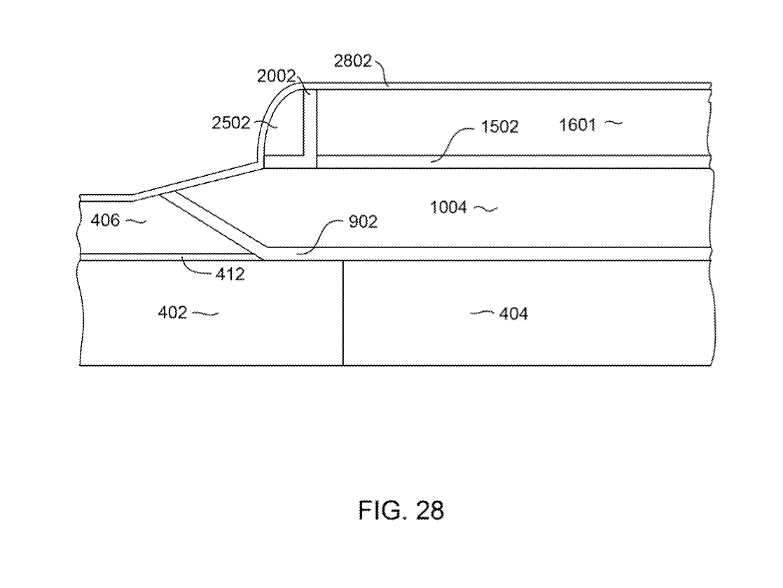

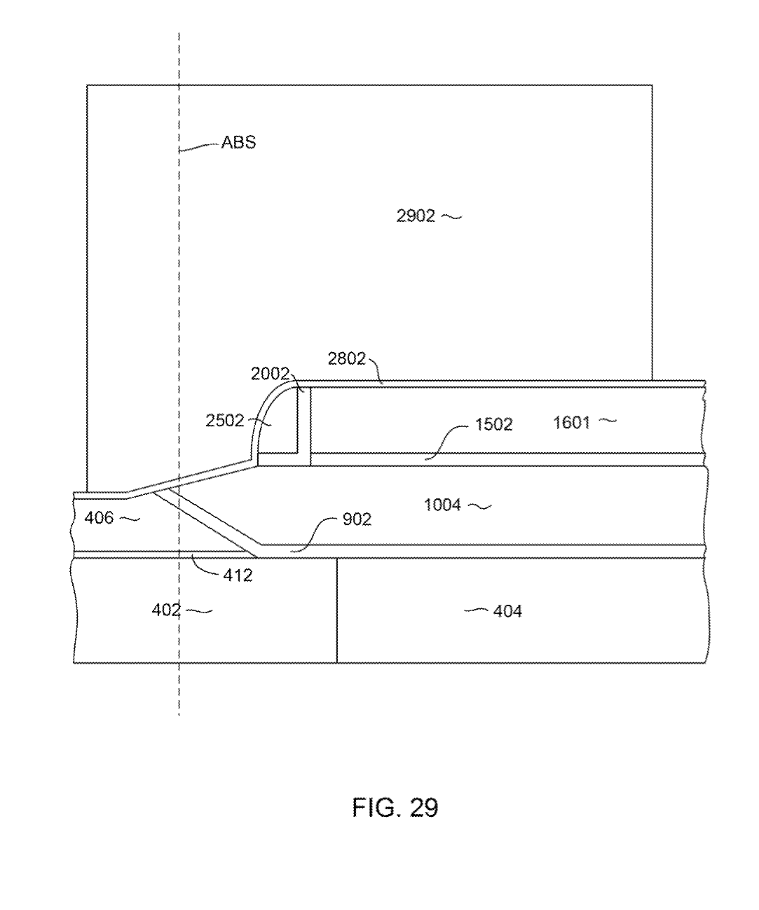

With reference now to FIG. 27 a further or additional ion milling is performed to remove a portion of the magnetic layer 1004 to form a trailing edge taper 2702 as shown in FIG. 27. Then, a non-magnetic trailing gap layer 2802 is deposited as shown in FIG. 28. The trailing gap layer 2802 is preferably a non-magnetic electrically conductive metal that can be used as an electroplating seed. Then, as shown in FIG. 29, a magnetic material is electroplated over the non-magnetic gap layer 2802 to form a trailing magnetic shield 2902. The electroplating can include forming an electroplating frame mask (not shown), electroplating a magnetic material such as NiFe or CoFe and then removing the electroplating fame mask.

After forming the trailing shield 2902, further processes will be performed to complete the magnetic write head. After these processes are completed, a lapping process will be performed to remove material from the left of the structure as shown in FIG. 29, stopping at the air bearing surface plane indicated by the dashed line denoted “ABS”.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic write head, comprising:
depositing a non-magnetic layer to a thickness that is at least as thick as a write pole to be formed;
forming a first mask having an edge;
performing an ion milling to remove a portion of the sacrificial layer, the ion milling being performed so that shadowing from the mask forms a tapered surface on the non-magnetic layer;
depositing a magnetic material, the tapered surface on the non-magnetic layer resulting in a leading edge taper on the magnetic material; and
forming a trailing edge taper on the magnetic material.

2. The method as in claim 1 wherein the ion milling is performed completely through the non-magnetic layer.

3. The method as in claim 1 wherein the non-magnetic layer comprises an end point detection layer and a layer of Ni—Cr.

4. The method as in claim 1 wherein the non-magnetic layer comprises an end point detection layer and a layer of Ru.

5. The method as in claim 1 wherein the non-magnetic layer comprises one or more layers of Cr, Ni—Cr or Ru.

6. The method as in claim 1 further comprising, before depositing the non-magnetic layer, depositing an adhesion layer.

7. The method as in claim 1 further comprising, before depositing the non-magnetic layer, depositing a Ta layer as an adhesion layer.

8. The method as in claim 1 further comprising, after depositing the magnetic material and before forming the trailing edge taper, performing a chemical mechanical polishing.

9. The method as in claim 1 wherein the chemical mechanical polishing is performed until the deposited magnetic material is substantially co-planar with the non-magnetic material.

10. The method as in claim 1 wherein the magnetic material is deposited by electroplating.

11. The method as in claim 1 wherein the magnetic material is deposited by sputter deposition.

12. A method for manufacturing a magnetic write head, comprising:
providing a substrate;
depositing a non-magnetic sacrificial layer over the substrate;
depositing a non-magnetic sacrificial layer over the substrate, the non-magnetic sacrificial layer having a thickness that is at least as great as a thickness of a write pole to be formed;
forming a mask over the non-magnetic sacrificial layer, the mask having an opening that exposes a portion of the sacrificial non-magnetic layer;
performing an ion milling to remove the sacrificial non-magnetic layer exposed through the opening in the mask, the ion milling being performed in such a manner that shadowing from the mask forms a tapered edge on the non-magnetic sacrificial layer;
depositing a magnetic material; and
performing a chemical mechanical polishing and terminating the chemical mechanical polishing when the sacrificial non-magnetic layer has been reached;
forming a non-magnetic step structure over the magnetic material, the step structure having a front edge that is located a desired distance from an intended air bearing surface plane;
depositing a non-magnetic material;
performing an ion milling to remove horizontally disposed portions of the non-magnetic material, leaving a non-magnetic bump formed on the front edge of the non-magnetic step; and
performing further ion milling to form a tapered surface on the magnetic layer.

13. The method as in claim 12 wherein the tapered surface extends from the non-magnetic bump at least to the intended air bearing surface plane.

14. The method as in claim 12 wherein the magnetic material forms an entire write pole, there being no other magnetic write pole layers deposited there-over.

15. The method as in claim 12 wherein the magnetic material is deposited by electroplating.

16. The method as in claim 12 wherein the magnetic material is deposited by sputter deposition.

17. The method as in claim 12 further comprising, after performing an ion milling to remove the sacrificial non-magnetic layer exposed through the opening in the mask, and before depositing the magnetic material depositing a seed layer that is resistant to chemical mechanical polishing.

18. The method as in claim 17 wherein the seed layer comprises one or more of Cr, Ru and CoFeNi or CoFe.

19. The method as in claim 17 wherein the seed layer comprises a layer of Cr, a layer of Ru deposited over the layer of Cr and a layer of CoFeNi or CoFe deposited over the layer of Ru.

20. The method as in claim 17 wherein the seed layer comprises a layer of Cr having a thickness of about 20 Angstroms, a layer of Ru having a thickness of about 80 Angstroms deposited over the layer of Cr and a layer of CoFeNi or CoFe having a thickness of about 110 Angstroms deposited over the layer of Ru.
